(19) United States
(12) Patent Application Publication
(10) Pub. No.: US 2016/0125689 A1
(43) Pub. Date: May 5, 2016

(54) CONCENTRIC CIRCULAR REELS GAME

(71) Applicant: URSA MAJOR MEDIA, INC., Reno, NV (US)

(72) Inventors: Benjamin C. Hoffman, Reno, NV (US); William F. Burrows, Reno, NV (US); Jason B. Newmark, Reno, NV (US); Lucas A. Munns, Reno, NV (US); Joseph G. Berger, Reno, NV (US); Farhad Ahmadzai, Reno, NV (US)

(21) Appl. No.: 14/931,230

(22) Filed: Nov. 3, 2015

Related U.S. Application Data
(60) Provisional application No. 62/074,803, filed on Nov. 4, 2014.

(51) Int. Cl. G07F 17/32; G07F 17/34

(52) U.S. Cl. CPC G07F 17/3213; G07F 17/34; G07F 17/3209; G07F 17/3248; G07F 17/3246; G07F 17/3223

(57) ABSTRACT

A method of operating a gaming device to play a concentric circular reels game may include the steps of: Displaying a plurality of concentric circular reels, each of the plurality of concentric circular reels comprising a plurality of reel symbols arranged so that each of the plurality of concentric circular reels appears to form at least a portion of a circle; receiving a wager; spinning the plurality of concentric circular reels; stopping at least two of the plurality of the concentric circular reels; evaluating the stopped concentric circular reels for a winning combination of reel symbols; determining whether a modifier is activated; terminating game play when there is no winning combination of reel symbols and no modifier is activated; evaluating the stopped concentric circular reels for a winning combination of reel symbols and at least one modifier when a modifier is activated; and terminating game play when there is no winning combination of reel symbols and at least one modifier.

### CROSS-REFERENCE TO RELATED APPLICATION

This application claims the benefit of provisional U.S. Patent Application Ser. No. 62/074,803, filed Nov. 4, 2014, which is incorporated herein by reference for all it discloses.

### FIELD OF THE INVENTION

This invention relates to gaming machines and devices, specifically virtual slot machines.

### BACKGROUND OF THE INVENTION

Virtual slot machines are well known. Unlike electromechanical slot machines, virtual slot machines have no or very few moving parts. One type of virtual slot machine allows a player to pay money into the machine, make a wager, and initiate play. Initiating play causes the spinning of virtual reels of symbols that are displayed to the player using a graphics display device. Each virtual reel may contain hundreds of symbols available to be displayed in a win evaluation game board. The virtual slot machine generates combinations of symbols randomly and certain winning symbol combinations are associated with awards. When such winning combinations are displayed in the win evaluation game board, the player is entitled to an award, and may collect it immediately or apply it to continue play.

### BRIEF SUMMARY OF THE INVENTION

A method of operating a gaming device to play a concentric circular reels game may include the steps of: Displaying a plurality of reels, each of the reels comprising a plurality of reel symbols arranged so that each of the plurality of concentric circular reels appears to form at least a portion of a circle; receiving a wager; spinning the plurality of concentric circular reels; stopping at least two of the plurality of the concentric circular reels; evaluating the stopped concentric circular reels for a winning combination of reel symbols; determining whether a modifier is activated; terminating game play when there is no winning combination of reel symbols and no modifier is activated; evaluating the stopped concentric circular reels for a winning combination of reel symbols and at least one modifier when a modifier is activated; and terminating game play when there is no winning combination of reel symbols and at least one modifier.

Also disclosed is a method of displaying winning symbol combinations on a virtual slot machine game board which may include the steps of: Spinning a plurality of concentric circular symbols on the virtual game board; stopping at least two of the plurality of spinning concentric circular symbols on the virtual game board; evaluating the stopped symbols on the game board for game modification symbols; and evaluating the stopped symbols on the game board for combinations of winning symbols.

A gaming system is also disclosed that may include a display system and an input system for accepting at least one input from a player. A processing system operatively associated with the display system and the input system, operates the display system and input system to: Display a plurality of concentric circular reels, each of the plurality of concentric circular reels comprising a plurality of reel symbols arranged so that each of the plurality of concentric circular reels appears to form at least a portion of a circle; receive a wager from the input system; spin the plurality of concentric circular reels; stop at least two of the plurality of the concentric circular reels; evaluate the stopped concentric circular reels for a winning combination of reel symbols; determine whether a modifier is activated; terminate game play when there is no winning combination of reel symbols and no modifier is activated; evaluate the stopped concentric circular reels for a winning combination of reel symbols and at least one modifier when a modifier is activated; and terminate game play when there is no winning combination of reel symbols and at least one modifier.

Also disclosed is a non-transitory computer-readable storage medium having computer-executable instructions embodied thereon that, when executed by at least one computer processor, cause the processor to: Display on a display system operatively associated with the processor a plurality of concentric circular reels, each of the plurality of concentric circular reels comprising a plurality of reel symbols arranged so that each of the plurality of concentric circular reels appears to form at least a portion of a circle; receive a wager from an input system operatively associated with the processor; spin the plurality of concentric circular reels; stop at least two of the plurality of the concentric circular reels; evaluate the stopped concentric circular reels for a winning combination of reel symbols; determine whether a modifier is activated; terminate game play when there is no winning combination of reel symbols and no modifier is activated; evaluate the stopped concentric circular reels for a winning combination of reel symbols and at least one modifier when a modifier is activated; and terminate game play when there is no winning combination of reel symbols and at least one modifier.

A concentric circular reels game for play on a gaming system having a display may include a plurality of reel symbols arranged to form a plurality of concentric circular reels on the display of the gaming system, wherein the concentric circular reels game spins the plurality of reel symbols after receiving a wager from a player, stops the spinning reel symbols after a time interval, evaluates the stopped reel symbols for game modification symbols, and evaluates the stopped reel symbols for a winning combination of reel symbols.

Finally, a method of operating a gaming device to play a concentric circular reels game may include the steps of: Displaying a plurality of concentric circular reels, each of the plurality of concentric circular reels comprising a plurality of reel symbols arranged so that each of the plurality of concentric circular reels appears to form at least a portion of a circle; receiving a wager; spinning the reels; stopping the reels; and evaluating the stopped reels for a winning combination of symbols.

### BRIEF DESCRIPTION OF THE DRAWINGS

Illustrative and presently preferred exemplary embodiments of the invention are shown in the drawings in which:

FIG. 1 is a pictorial diagram of an electronic gaming system that may be used to implement the concentric circular reels game of the present invention;

FIGS. 2(a-d) are pictorial representations of successive screen displays of a first embodiment of the concentric circular reels game;

FIG. 3 is a flow chart diagram of one embodiment of a method for playing the concentric circular reels game;

FIG. 4 is a schematic representation of the major components of the electronic gaming system illustrated in FIG. 1;

FIG. 5 is a schematic representation of a network of electronic gaming systems that may be used to implement the concentric circular reels game;

FIGS. 6(a-c) are pictorial diagrams of a second embodiment of an electronic gaming system of the concentric circular reels game;

FIG. 7 is a pictorial representation of a third embodiment of an electronic gaming system of the concentric circular reels game;

FIG. 8 is a pictorial representation of a fourth embodiment of an electronic gaming system of the concentric circular reels game;

FIG. 9 is a pictorial representation of a fifth embodiment of an electronic gaming system of the concentric circular reels game;

FIG. 10 is a pictorial representation of a sixth embodiment of an electronic gaming system of the concentric circular reels game;

FIG. 11 is a pictorial representation of a seventh embodiment of an electronic gaming system of the concentric circular reels game; and

FIG. 12 is a pictorial representation of an eighth embodiment of an electronic gaming system of the concentric circular reels game.

### DETAILED DESCRIPTION OF THE INVENTION

Various embodiments of a concentric circular reels game 10 according to the teachings of the present invention are shown and described herein as they could be implemented or played on an electronic gaming system 12 of the type well-known in the art. Alternatively, various embodiments of the concentric circular reels game 10 could be implemented on other systems and devices and in other gaming environments, as will be described in greater detail herein.

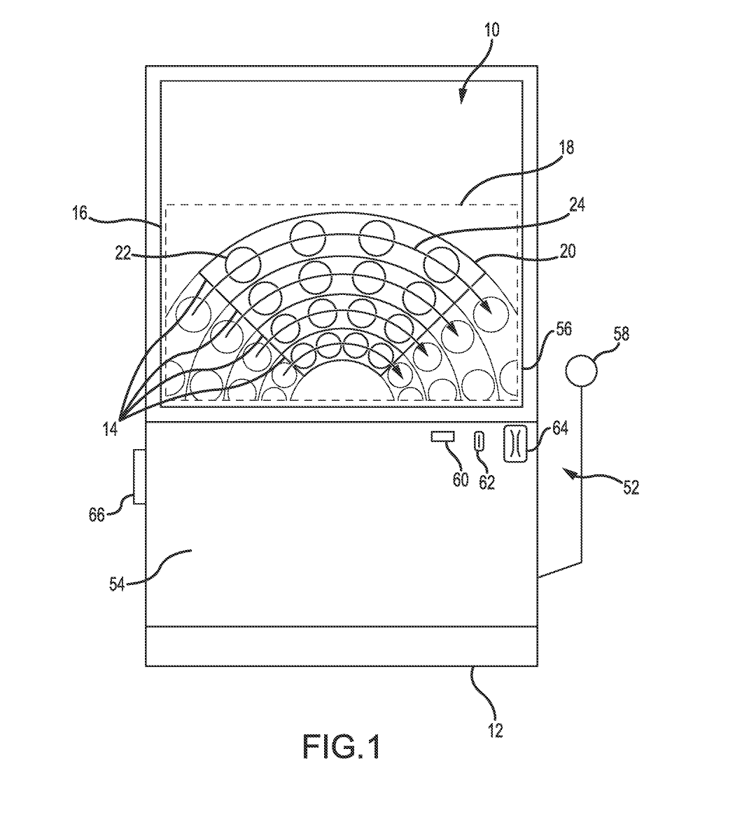

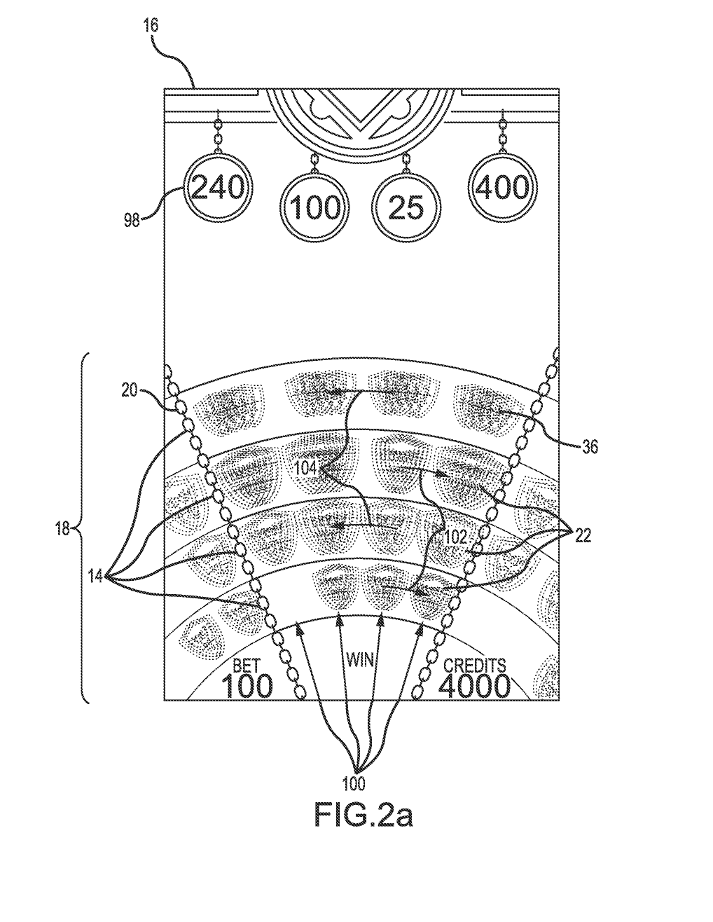

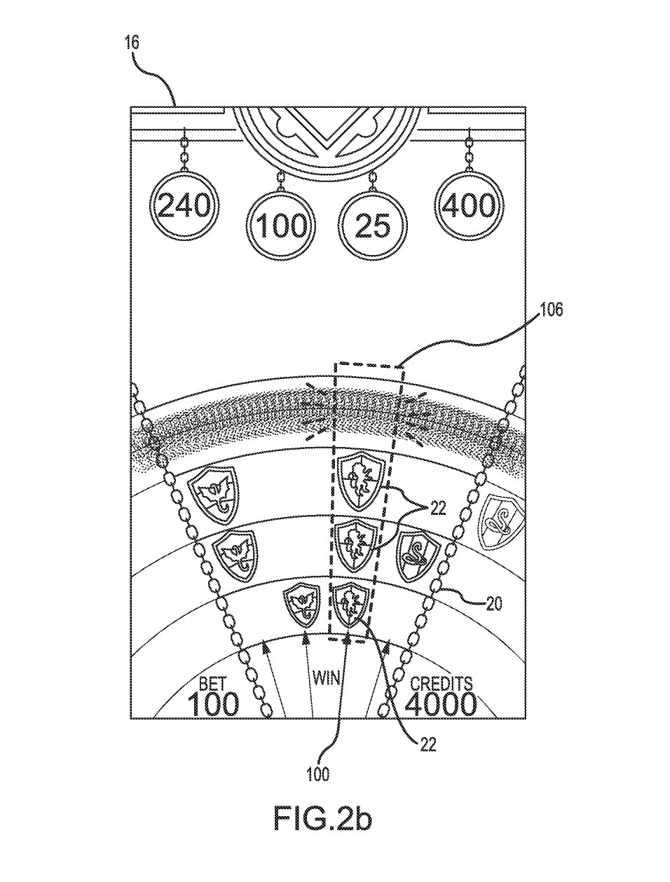

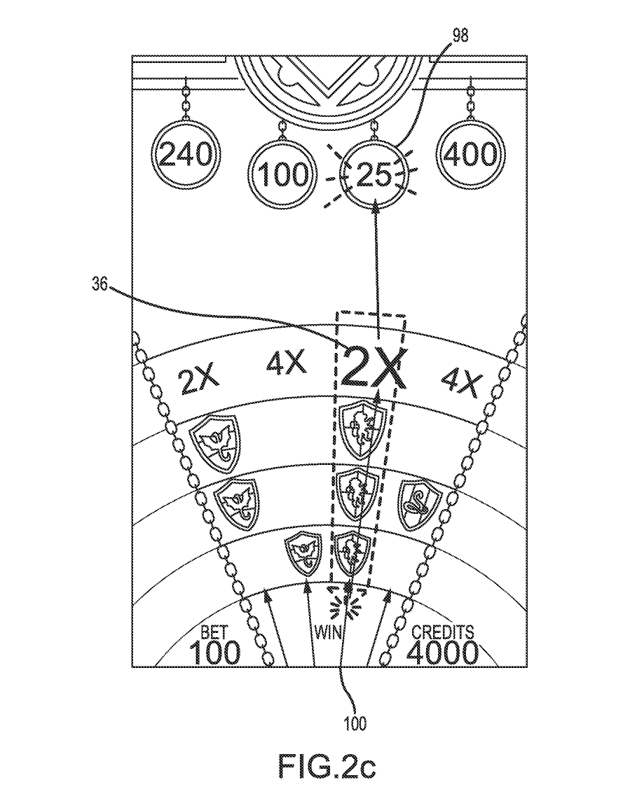

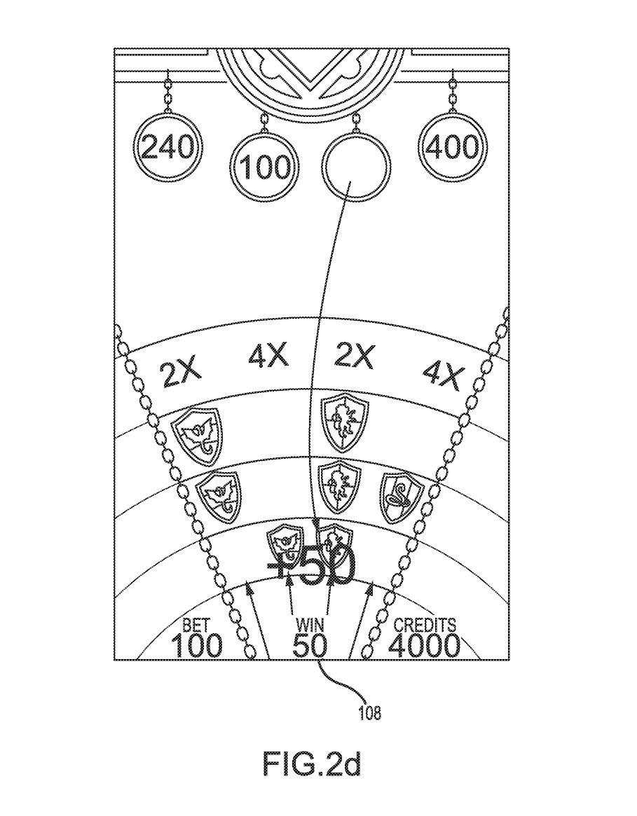

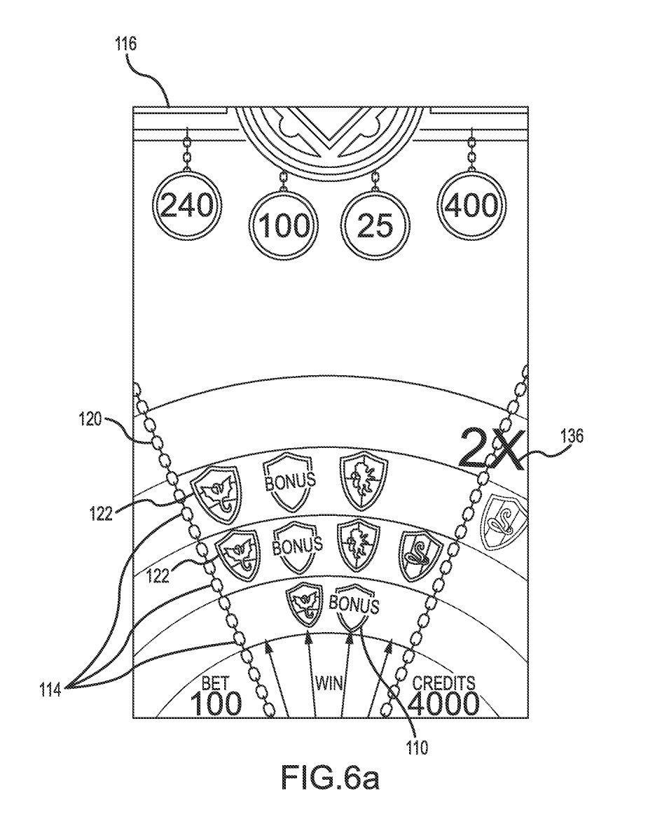

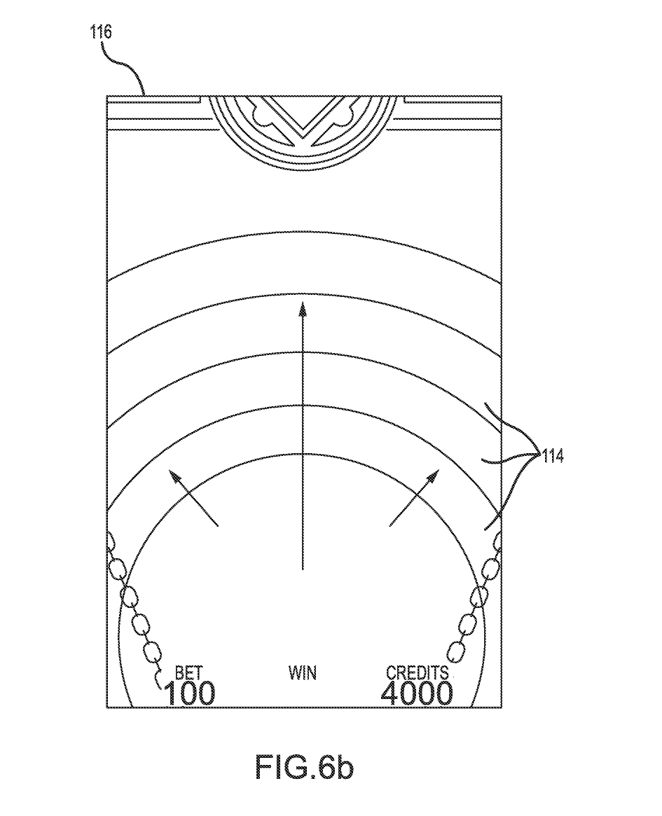

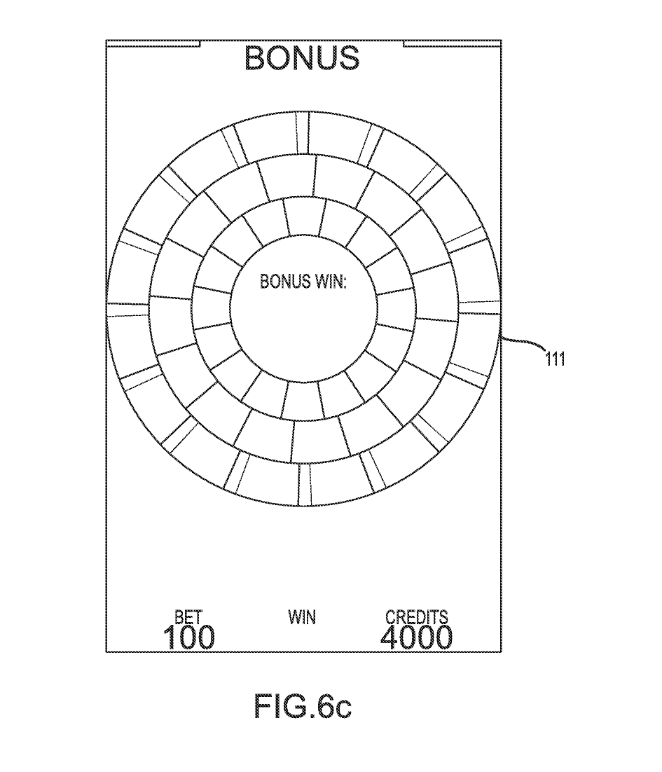

Referring primarily to FIGS. 1 and 2, one embodiment of the concentric circular reels game 10 may comprise a plurality of circular reels 14 that may be displayed on a suitable display system 16 operatively associated with electronic gaming system 12. The circular reels 14 may be displayed within the perimeter of a ‘game board’ 18 also displayed on display system 16. In some embodiments, the concentric circular reels 14 are displayed so that they appear to form at least portions of respective circles in a concentric or nested arrangement, as illustrated in FIG. 1. In other embodiments, or during certain times or sequences during game play, the concentric circular reels 14 may be displayed so that they appear as full circles, again in a concentric or nested arrangement. See FIG. 6(c). In some embodiments, game board 18 may also comprise a smaller active symbol area 20.

Each circular reel 14 may comprise a plurality of reel symbols 22 that may be activated or ‘spun’ at the appropriate time during game play so as to cause the various reel symbols 22 comprising each circular reel 14 to appear to a game player (not shown) as if they are spinning. When the concentric circular reels 14 stop spinning, the gaming system 12 evaluates the symbols 22 within the active symbol area 20 at certain times during game play to determine if a winning combination of symbols 20 is present, as explained in greater detail below.

The concentric circular reels game 10 may also comprise one or more game modifiers 36. The game modifier(s) 36 may be displayed and/or activated at certain times during game play, although game modifiers 36 need not be activated during every game or during every sequence of game play. Game modifiers 36 may be displayed in any convenient area of game board 18. Game modifiers 36 may also be displayed in one or more of the circular reels 14, either alone or in conjunction with one or more reel symbols 22.

As will be described in further detail herein, certain game modifiers 36 may modify or otherwise enhance a win associated with a winning combination of symbols. Other game modifiers 36 may modify or otherwise enhance a win associated with the game 10 as a whole, such as a bonus trigger or a credit award. By way of example, in the particular embodiments shown and described herein, the game modifiers 36 may comprise a ‘wild’ symbol, a multiplier symbol, a bonus symbol, a feature modifier symbol, and a credit award symbol. Alternatively, other types game modifiers 36 having other effects on game play may be used.

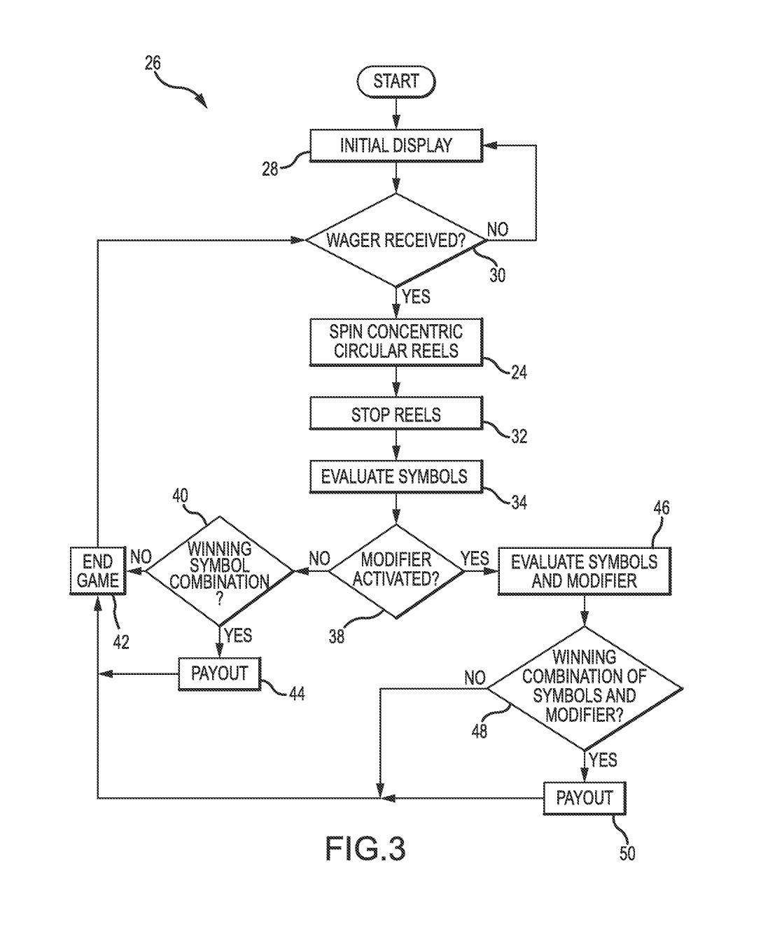

With reference now primarily to FIG. 3, and with occasional reference to FIGS. 1 and 2, the electronic gaming system 12 may be operated in accordance with a method 26 to play the concentric circular reels game 10. A first step 28 in method 24 may involve the initial display of concentric circular reels 14. The initial display of circular reels 14 may occur during an idle state, i.e., when the gaming system 12 is awaiting a game player. The initial display of circular reels 14 may also comprise a time period between when a game player engages the system 12 for play, but before placing a wager. In any event, upon receipt of a suitable wager (e.g., at step 30), gaming system 12 may activate or spin the concentric circular reels at step 24. After a suitable time interval, the system 12 may stop at least two of the spinning circular reels 14 (i.e., at step 32) and evaluate, at step 34, the symbols 22 in the stopped circular reels 14 that are displayed or contained within the active symbol area 20. At this time the system 12 may then determine, i.e., at step 38, whether a game modifier 36 is activated. In some embodiments, the one or more game modifiers 36 may be activated on a random basis. In other embodiments, or during other game play sequences, the system 12 may activate one or more game modifiers 36 based on the results of the evaluation of the stopped reel symbols 22. In this regard it should be noted that the reel symbol combinations required to activate one or more of the game modifiers 36 may or may not be the same as the reel symbol combinations required to trigger a payout to the player.

Regardless of how the game modifiers 36 may be activated, if no game modifier 36 is activated, i.e., as determined during step 38, method 26 may proceed to step 40 to determine whether the stopped reel symbols 22 in the active symbol area 20 comprise a winning combination of symbols. If no winning combination of reel symbols 22 is present, method 26 may terminate game play at step 42 and await receipt of a new wager at step 30 to begin a new game. Alternatively, if a winning combination of reel symbols 22 is present, method 26 may advance to step 44 and award a payout to the player. The payout at step 44 may be in the form of cash, monetary credits, or casino credits, although other types of payouts are possible and may be used. After payout at step 44, the game ends at step 42, and the method 26 awaits receipt of a new wager at step 30 to begin a new game.

On the other hand, if one or more game modifiers 36 are activated, i.e., as determined during step 38, method 26 may proceed to step 46 and evaluate the combination of reel symbols 22 in conjunction with the one or more activated game modifiers 36. If no winning combination of reel symbols 22 and activated game modifiers 36 is present, i.e., as determined during step 48, method 26 may proceed to step 42 and end the game. Alternatively, if a winning combination of reel symbols 22 and one or more game modifiers 36 is present, method 26 may proceed to step 50 and award a payout to the player. Depending on the nature of the particular activated game modifier 36, the payout at step 50 may be more valuable and elaborate than the payout awarded to the player at step 44. Alternatively, and as will be described in further detail herein, a winning combination of reel symbols 22 and activated game modifiers 36 may trigger other game play sequences, benefits, or awards. After awarding the player a payout at step 50, the method 26 may proceed to step 42, end the game and/or await receipt of a new wager.

Significant advantages of the concentric circular reels game 10 according to the teachings of the present invention include the visual richness and diversity of the circular reels, the high degree of player interactivity, and the flexible display possibilities permitted by the display system 16, as compared to other slot machine gaming devices. The wide variety of win evaluation methods made possible by circular reels invigorates the gaming experience and rewards the player with unexpected winning symbol combinations. As a consequence, the concentric circular reels game 10 may attract new players to the gaming system 12 and retain them longer throughout successive games.

Having briefly described the concentric circular reels game 10, as well as some of its more significant features and advantages, various exemplary embodiments and alternative configurations of the concentric circular reels game will now be described in detail. However, before proceeding with the detailed description it should be noted that while the concentric circular reels game 10 is shown and described herein as it could be embodied or played on an electronic gaming system 12 of the type well-known in the art in a casino environment, the present invention is not limited to play on such devices and in such environments. For example, alternative embodiments could be implemented as specific gaming applications provided on a wide variety of computer systems, such as personal computer systems, ‘smart’ phones, and tablet computers, that are operatively connected to a suitable gaming network. Consequently, the present invention should not be regarded as limited to the particular devices, networks, and gaming environments shown and described herein.

Referring back now to FIG. 1, and as briefly described above, in one embodiment the concentric circular reels game 10 may be configured to be played on an electronic gaming system 12 of the type well-known in the art and widely used in casino environments. Alternatively, the concentric circular reels game 10 could be configured or implemented for use as a specific gaming application or “app” on other types of computer systems, such as personal computers, smart phones, or tablet computers that are operatively connected to a suitable gaming network. In the particular application and environment shown and described herein, the electronic gaming system 12 may comprise a display system 16, an input system 52 to accept an input from a player, and a processing system 54. The display system 16 may comprise a video touchscreen 56, in which case the video touchscreen 56 may also comprise a portion of the input system 52 in that it may be configured to receive input from the player. Input system 52 may also comprise a handle 58 that may be used by a player to initiate the circular reel spinning sequence. Input system 52 may also comprise any of a wide range of other devices, such as one or more buttons 60, coin slots 62, and card readers 64, either separately or in combination with handle 58 in order to allow a player to provide the necessary or desired input to the system 12.

The electronic gaming system 12 may also comprise a communications module 66. Communications module 66 may be operatively associated with the processing system 54 of the electronic gaming system 12 so as to allow the gaming system 12 to communicate with a network 86. The communications module 66 may comprise any of a wide variety of communications devices, such as devices configured to communicate via Ethernet, 12C, RD-232, USB, RS-485, IEEE 1394, or Netplex communications technology, as would become apparent to persons having ordinary skill in the art after having become familiar with the teachings provided herein. Communications module 66 may also utilize other communication interfaces and protocols now known in the art, or that may be developed in the future, that would be suitable for the intended use and gaming environment. The communications module 66 may operate on or interface with wired or wireless channels, and may be used to communicate with personal devices operating through known wireless technologies.

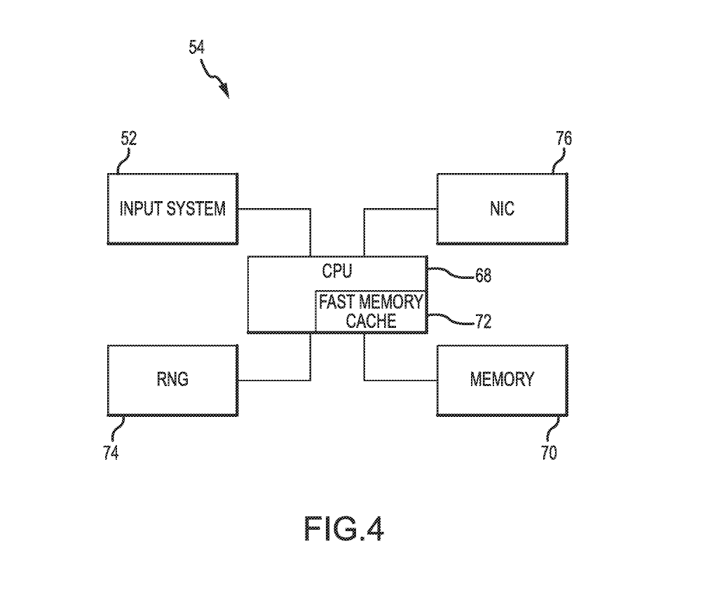

Referring now to FIG. 4, the processing system 54 of electronic gaming system 12 may comprise a logic component that is operatively connected to internal components that manage the various gaming systems and operations for the electronic gaming system 12 that are imbedded in software and implemented by a central processing unit (CPU) 68. In one embodiment, the processing system 54 of the electronic gaming system 12 may comprise the CPU 68 and a memory storage mechanism 70 for storing gaming operations and instructions to implement method 26. CPU 68 may use a fast memory cache 72 to access data or software stored in the memory 70. In another embodiment, the memory 70 may comprise a non-transitory computer-readable storage medium having computer-executable instructions embodied within so that, when executed by the CPU 68, cause the processor to display and carry out the steps of the circular reels game 10 on the display system 16 of the electronic gaming system 12. As would be familiar to one of ordinary skill in the art after familiarizing herself with the teachings of the present invention, the logic component is not limited to the CPU 68 and instead may include a plurality of logic gates and switches that may either be programmed (e.g., a field programmable gate array) or may be an application-specific integrated circuit (e.g., an ASIC).

In an embodiment, CPU 68 may implement the method 26 via instructions imbedded in software and stored in the memory 70. The input system 52 may permit the player to interact with the method 26 and input desired parameters to the game, with the processing system 54 processing the player's inputs and executing them according to the software stored in the memory 70.

The software may include a random number generator (RNG) 74 for randomly selecting reel symbols 22 and/or game modifiers 36 for the electronic gaming system 12 to display on display system 16. By way of example, reel symbols 22 may comprise numbers, letters, geometric figures, animated figures, words, bonus multipliers, or pictures. Game modifiers 36 comprise wild symbols, multipliers, bonus symbols, credit awards, or other special feature symbols. In an embodiment, random number selection may comprise using the RNG 74 as a basis for selecting reel symbols 22 from a set of game symbols for the electronic gaming system 12 to display on display system 16. In an embodiment, the set of reel symbols 22 that may appear in the reel windows 14 may comprise a set of approximately 300 symbols for each reel. In another embodiment, the system and method of selecting symbols from among the set of game symbols may simulate systems that provide for random number generation. By way of non-limiting example, a well-known lottery-based system may be used.

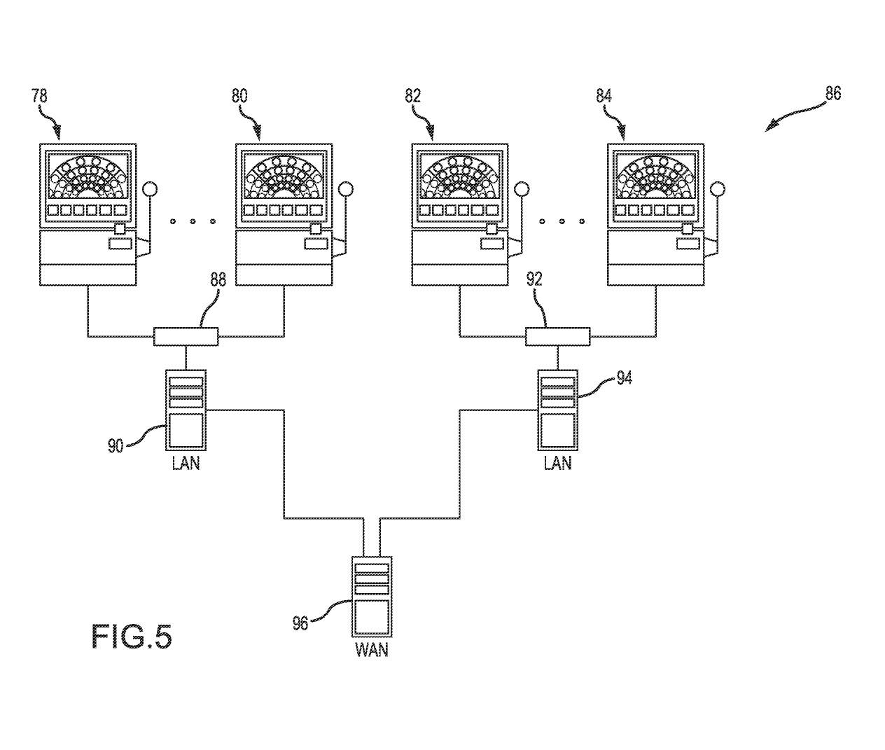

Referring now to FIGS. 4 and 5, in one embodiment, the processing system 54 may also comprise a network interface card (NIC) 76 to permit communications between a plurality of electronic gaming systems 78-84 and processors within a network 86. The NIC 76 may use well-known networking protocols to communicate with other networked devices, as already described. The electronic gaming systems 78-84 may be networked together to allow for a progressive jackpot, in which the sum of the potential winning prizes is shared between the electronic gaming systems 78-84 on the network 86.

As illustrated in FIG. 5, the network 86 may comprise the networked electronic gaming systems 78-84, each of which may be similar to the electronic gaming system 12 described above. The networked gaming systems 78 and 80 may connect to a node 88, which communicates with a local area network (LAN) server 90. The networked gaming systems 82 and 84 may connect to a node 92, which communicates with a LAN server 94. The notes 88 and 92 may be hubs, routers, bridges, gateways, or similar communications devices that permit communications between the networked gaming systems 78-84. A wide area network (WAN) may be created by linking the LANs 90 and 94 with a WAN server 96. WANs and LANs are well known and may operate in a similar manner, but may be differentiated by geography (e.g., casino floors versus different casinos).

The electronic gaming system 12 may be operated in accordance with method 26 to allow a player to play the concentric circular reels game 10. Referring now to FIGS. 1-3, a first step 28 of method 26 may involve the display of a plurality of circular reels 14 on game board 18. In this particular embodiment, game board 18 comprises four circular reels 14 displayed so that they appear to form portions of respective circles in a concentric or nested arrangement. Further, the reel symbols 22 contained within the active symbol area 20 are highlighted or otherwise displayed so that the player will recognize that the reel symbols 22 are the reel symbols 22 that will be evaluated for winning combinations and/or to activate one or more game modifiers 36 if the game modifiers 36 are activated based on the reel symbols 22. Reel symbols 22 outside the active symbol area 20 may be displayed as phantom or greyed-out images to indicate that they are not in play.

In some embodiments, one or more game modifiers 36 also may be displayed along with the circular reels 14, although they need not be so displayed. Game modifiers 36 may be displayed in separate areas on game board 18 as separate symbols. Alternatively, game modifiers 36 may be displayed in one or more circular reels 14, either by themselves or along with reel symbols 22. For example, and with reference now to FIGS. 2(a-d), the three circular reels 14 closest to the bottom of the game board 18 comprise reel symbols 22. However, the circular reel 14 farthest from the bottom of the game board 18 (i.e., the upper-most circular reel 14) contains game modifiers 36. Additional game modifiers 36, such as win modification symbols 98 may be displayed near the upper portion of game board 18. In this embodiment, the reel symbols 22 contained within the active symbol area 20 may be evaluated by the method 26 using paylines 100 that begin at the innermost circular reel 14 and proceed outward.

After the player inputs a wager at step 30, the method 26 spins the symbols 22 and game modifiers 36 within the circular reels 14 at step 24. In this embodiment, half the reels spin in a clockwise direction 102, and half the reels spin in a counterclockwise direction 104. In other embodiments the circular reels 14 may be spun or rotated in the same direction. After a suitable period of time, the method 26 may stop at least two, and in this embodiment, the three circular reels 14 closest to the bottom of the game board 18 in step 32. See FIG. 2(b). The upper reel 14, containing game modifiers 36, continues to spin. At this point, there are seven reel symbols 22 within the active symbol area 20. The method 26 evaluates the symbols at step 34 to determine if a game modifier 36 should be activated at step 38. In this embodiment, because three reel symbols 22 have aligned over one of the paylines 100 in the active game area 20, the method 26 activates a game modifier 36, which is depicted by the white dotted border 106. Other embodiments may use different evaluation criteria to determine whether the symbols 22 in the active symbol area 20 should activate a game modifier 36.

The method 26 may then proceed to step 46 and evaluate the combination of symbols 22 and game modifier 36. In this embodiment, the outer circular reel 14, i.e., containing the game modifiers 36, is first brought to a stop. Method 26 then evaluates, i.e., at step 48, the combination of reel symbols 22 and game modifier(s) 36 along the already-established payline 100. In this particular example, method 26 detects a winning combination, and proceeds to step 50 to award a payout to the player. The payout at step 50 may involve the method 26 extending the payline 100 upward until it contacts the additional win modification symbol 98 that is directly above the payline. See FIG. 2(d). Method 26 will then multiply the numerical values represented by the additional win modification symbol 98 and game modifier 36 (in outer circular reel 14) together to calculate the final win payout 108. The method then proceeds to step 42 and ends the game.

Alternative embodiments and/or play sequences are possible. For example, and with reference now primarily to FIGS. 6(a-c), an alternative way for method 26 to reward the player with a payout (e.g., at step 44) may involve an evaluation of stopped symbols 122 to determine if a game modifier 136 is activated at step 38. In this embodiment, the method 26 does not activate a game modifier 136 at step 38, and the method 26 proceeds to step 40 to evaluate the symbols 122 that have stopped within the active symbol area 120 for a winning combination of symbols 122. Special bonus symbols 110 are present in the active symbol area 120 and qualify as a winning combination of symbols 122. The method 26 proceeds to step 44 to award a payout to the player. As depicted in FIG. 6(b), in this embodiment, the gaming system 112 reduces the size of the circular reels 114 displayed on the display system 116 until each circular reel 114 appears to form a full circle. The reels 114 now appear in the shape of a large target circle 111, depicted in FIG. 6(c), and the method 26 may now evaluate the large target circle 111 for additional winning combinations of symbols 122.

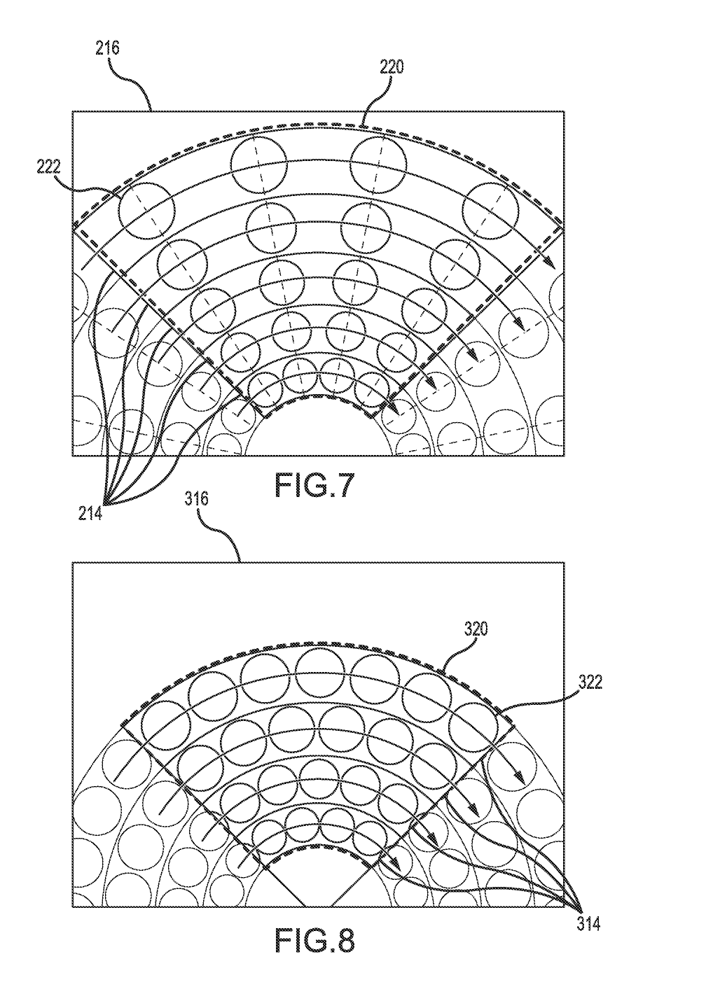

The concentric circular reels game 10 and method 26 permit several variations in how the circular reels 14 and symbols 22 are presented to the player. For example, in a third embodiment, the number of symbols 222 displayed within the active symbol area 220 by the display device 216 may remain constant, as shown in FIG. 7. This results in a greater distance between symbols 222 in circular reels 214 that are farther away from the axis around which the symbols 222 in the circular reels 214 rotate. Alternatively, in a fourth embodiment depicted in FIG. 8, the distance between symbols 322 in circular reels 314 remains constant. This results in a greater number of symbols 322 in circular reels 314 that are farther away from the axis around which the symbols 322 in the circular reels 314 rotate or spin.

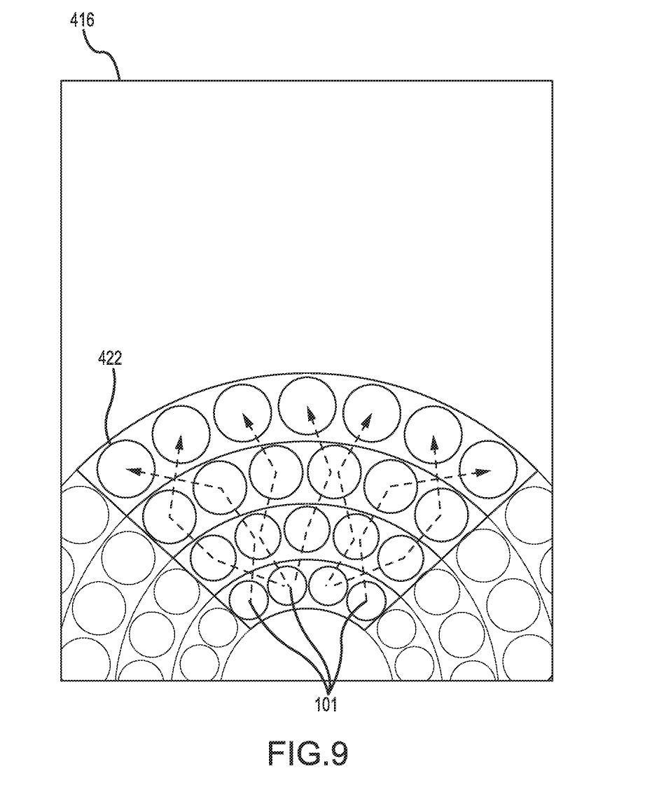

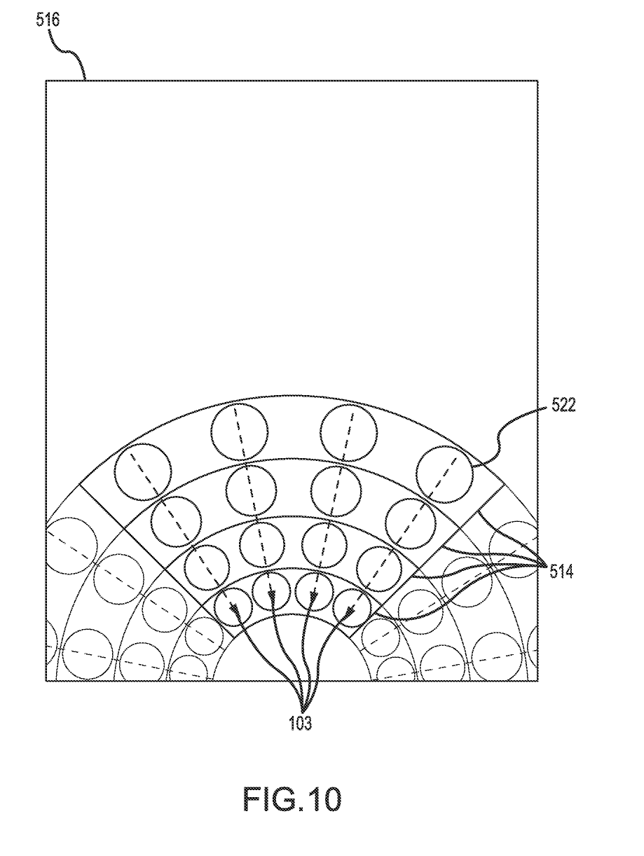

The concentric circular reels game 10 and method 26 also permit considerable variation in how winning paylines 100 and ‘ways pays’ are determined. In a fifth embodiment, the method 26 may evaluate winning combinations of symbols 422 using adjacent symbol paylines 101 , as shown on display system 416 in FIG. 9. In a sixth embodiment, the method 26 may evaluate winning combinations of symbols 522 using radial symbol paylines 103, as shown on display system 516 in FIG. 10. Radial symbol paylines 103 may begin with the outermost circular reel 514 and proceed inward, as shown in this fifth embodiment; alternatively, the radial symbol paylines 103 may begin with the innermost circular reel 514 and proceed outward.

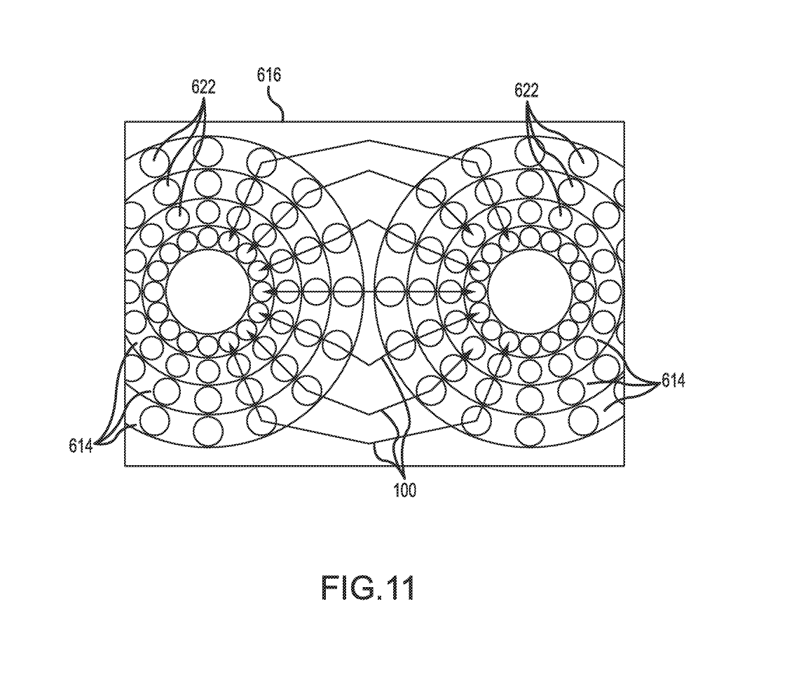

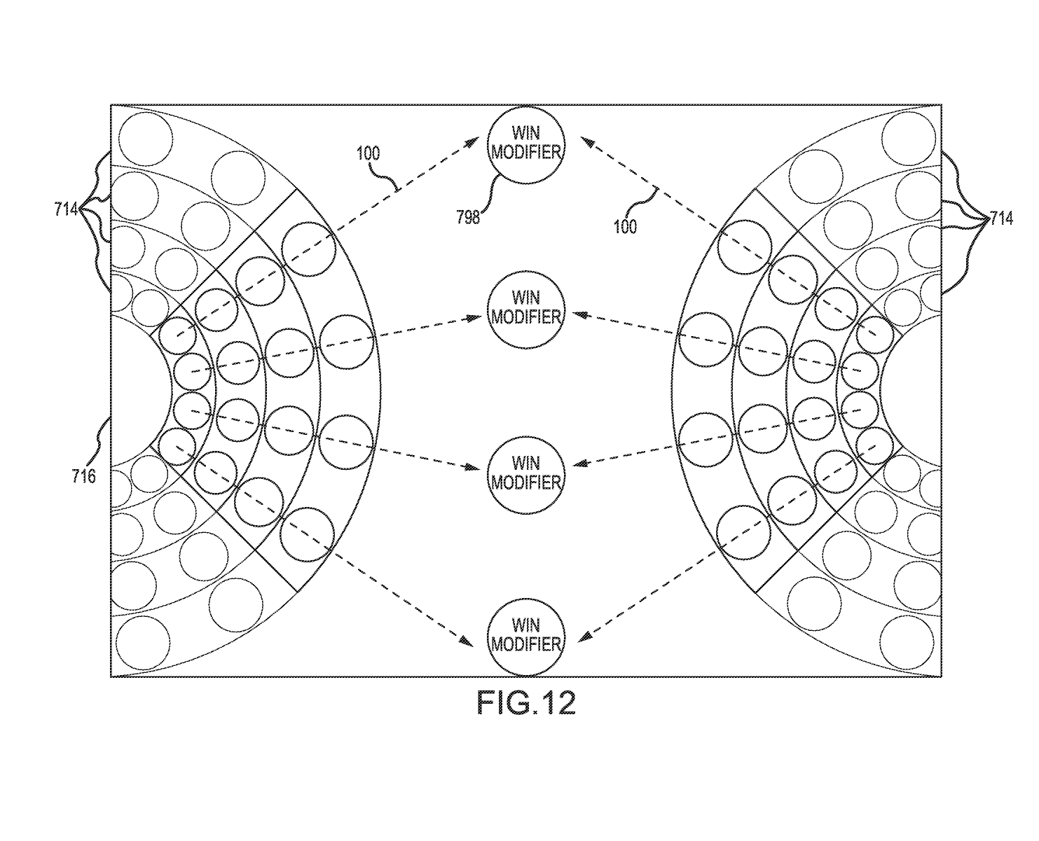

In a seventh embodiment, depicted in FIG. 11, display system 616 may display multiple separate sets of circular reels 614, with each set of circular reels 614 comprising separate symbols 622. When the method 26 evaluates the symbols 622 for winning combinations, it may utilize paylines 100 that link together the two separate sets of circular reels 614 to form additional winning combinations of symbols 622. In an eighth embodiment shown in FIG. 12, the display system 716 may display multiple separate sets of circular reels 614 that both interact with a set of additional win modification symbols 798 through the use of shared paylines 100.

The gaming device 12 may employ the steps of method 26 described above to evaluate circular reels of any configuration or shape. The examples above are intended to be illustrative but non-limiting and non-exhaustive.

Having herein set forth the various embodiments of the present invention, it is anticipated that suitable modifications can be made thereto which will nonetheless remain within the scope of the invention.

What is claimed is:

1. A method of operating a gaming device to play a concentric circular reels game, comprising:
displaying a plurality of concentric circular reels, each of the plurality of concentric circular reels comprising a plurality of reel symbols arranged so that each of the plurality of concentric circular reels appears to form at least a portion of a circle;
receiving a wager;
spinning the plurality of concentric circular reels;
stopping at least two of the plurality of the concentric circular reels;
evaluating the stopped concentric circular reels for a winning combination of reel symbols;
determining whether a modifier is activated;
terminating game play when there is no winning combination of reel symbols and no modifier is activated;
evaluating the stopped concentric circular reels for a winning combination of reel symbols and at least one modifier when a modifier is activated; and
terminating game play when there is no winning combination of reel symbols and at least one modifier.

2. The method of claim 1, wherein said evaluating the stopped concentric circular reels further comprises:
defining a payline; and
evaluating the reel symbols along the payline for a winning combination of reel symbols.

3. The method of claim 2, further comprising:
stopping additional concentric circular reels; and
evaluating the reel symbols of newly stopped additional concentric circular reels and previously stopped concentric circular reels along the payline for a winning combination of reel symbols.

4. The method of claim 2, wherein a game player defines the payline.

5. The method of claim 2, wherein the modifier comprises a plurality of additional win modification symbols and wherein said evaluating the stopped concentric circular reels for a winning combination of symbols and at least one modifier comprises determining whether at least one additional win modification symbols is aligned with the payline.

6. The method of claim 1, wherein said evaluating the stopped concentric circular reels further comprises:
defining a ways pays combination; and
evaluating the reel symbols along the ways pays combination for a winning combination of symbols.

7. The method of claim 1, further comprising displaying an active symbol area and wherein said evaluating comprises evaluating reel symbols within the active symbol area

8. The method of claim 1, further comprising displaying a game board, the game board defining a perimeter, and wherein the plurality of reels are displayed within the perimeter of the game board.

9. The method of claim 1, further comprising:
reducing the size of each of the plurality of concentric circular reels so that each of the plurality concentric circular reels appears to form a full circle; and
further evaluating bonus win combinations of all the reel symbols comprising the plurality of concentric circular reels displayed as full circles.

10. A method for displaying winning symbol combinations on a virtual slot machine game board, comprising:
spinning a plurality of concentric circular symbols on the virtual game board;
stopping at least two of the plurality of spinning concentric circular symbols on the virtual game board;
evaluating the stopped symbols on the game board for game modification symbols; and
evaluating the stopped symbols on the game board for combinations of winning symbols.

11. The method of claim 10, wherein the concentric circular symbols spin in opposite directions.

12. The method of claim 10, wherein multiple separate sets of concentric circular symbols spin on the virtual game board.

13. The method of claim 10, wherein the stopped symbols on the game board are evaluated using radial paylines.

14. The method of claim 10, wherein the stopped symbols on the game board are evaluated using adjacent symbol paylines.

15. The method of claim 10, wherein the stopped symbols on the game board are evaluated using paylines that begin with the innermost concentric circular reel and proceed outward.

16. The method of claim 10, wherein the stopped symbols on the game board are evaluated using paylines that begin with the outermost concentric circular reel and proceed inward.

17. The method of claim 10, wherein the stopped symbols on the game board are evaluated using additional win modification symbols which create additional winning symbol combinations.

18. A gaming system, comprising:
a display system;
an input system for accepting an input from a player;
a processing system operatively associated with said display system and said input system, said processing system operating said display system and said input system to:
display a plurality of concentric circular reels, each of the plurality of concentric circular reels comprising a plurality of reel symbols arranged so that each of the plurality of concentric circular reels appears to form at least a portion of a circle;
receive a wager;
spin the plurality of concentric circular reels;
stop at least two of the plurality of the concentric circular reels;
evaluate the stopped concentric circular reels for a winning combination of reel symbols;
determine whether a modifier is activated;
terminate game play when there is no winning combination of reel symbols and no modifier is activated;
evaluate the stopped concentric circular reels for a winning combination of reel symbols and at least one modifier when a modifier is activated; and
terminate game play when there is no winning combination of reel symbols and at least one modifier.

19. The gaming system of claim 18, wherein said display system comprises a video touchscreen.

20. The gaming system of claim 18, wherein said input system comprises one or more selected from the group consisting of a handle, a button, a coin slot, and a card reader.

21. The gaming system of claim 18, further comprising a communications module operatively associated with said processing system to allow said gaming system to communicate with a network.

22. A non-transitory computer-readable storage medium having computer-executable instructions embodied thereon that, when executed by at least one computer processor, cause the processor to:
display on a display system operatively associated with the processor a plurality of concentric circular reels, each of the plurality of concentric circular reels comprising a plurality of reel symbols arranged so that each of the plurality of concentric circular reels appears to form at least a portion of a circle;
receive a wager from an input system operatively associated with the processor;
spin the plurality of concentric circular reels;
stop at least two of the plurality of the concentric circular reels;
evaluate the stopped concentric circular reels for a winning combination of reel symbols;
determine whether a modifier is activated;
terminate game play when there is no winning combination of reel symbols and no modifier is activated;
evaluate the stopped concentric circular reels for a winning combination of reel symbols and at least one modifier when a modifier is activated; and
terminate game play when there is no winning combination of reel symbols and at least one modifier.

23. A concentric circular reels game for play on a gaming system having a display, comprising a plurality of reel symbols arranged to form a plurality of concentric circular reels on the display of the gaming system, wherein said concentric circular reels game spins the plurality of reel symbols after receiving a wager from a player, stops the spinning reel symbols after a time interval, evaluates the stopped reel symbols for game modification symbols, and evaluates the stopped reel symbols for a winning combination of reel symbols.

24. A method of operating a gaming device to play a concentric circular reels game, comprising:
displaying a plurality of concentric circular reels, each of the plurality of concentric circular reels comprising a plurality of reel symbols arranged so that each of the plurality of concentric circular reels appears to form at least a portion of a circle;
receiving a wager;
spinning the reels;
stopping the reels; and
evaluating the stopped reels for a winning combination of symbols.
